(19) United States
(12) Patent Application Publication
(10) Pub. No.: US 2014/0207438 A1
(43) Pub. Date: Jul. 24, 2014

(54) ASL Converter

(71) Applicant: Raanan Liebermann, North Haven, CT (US)

(72) Inventor: Raanan Liebermann, North Haven, CT (US)

(73) Assignee: Raanan Liebermann, North Haven, CT (US)

(21) Appl. No.: 13/746,060

(22) Filed: Jan. 21, 2013

(51) Int. Cl. G06F 17/28; F21V 8/00

(52) U.S. Cl. CPC G06F 17/289; G02B 6/0008
USPC 704/3; 359/454

(57) ABSTRACT

A system for converting English sentences and/or signing in English Sign Language (ESL) into American Sign Language (ASL) as well as translating in reverse order is provided, including a color screen made of fiber optic filaments.

### CROSS REFERENCE TO RELATED APPLICATION(S)

This application claims the benefit of U.S. provisional patent application No. 61/589,391, filed Jan. 22, 2012, entitled “THE ASL CONVERTER.”

### BACKGROUND

1. Field of the Invention

The present invention relates to a system and method for converting at least one of a at least one English sentence(s) and English Sign Language (ESL) into American Sign Language (ASL) that when signed could be understood by deaf persons who use or learn to use ASL. The innovation described herein could be utilized in conjunction with the Signtel Interpreter, by its own or in conjunction with other interfaced signing products.

It further enables to convert other languages into ASL.

2. Prior Art

Machine translation of English voice or text to Sign Language is prior art of Liebermann in the Telephone For The Deaf, now Ser. No. 5,982,853 and RE41,002 and also in Liebermann et al. now U.S. Pat. No. 7,774,194. However, in such prior art the translation is into English Sign Language and not American Sign Language, in the sense that the signs utilized are ASL signs and except the ability to ignore the auxiliaries as is done in ASL, the sentence structure is that of ESL. The present disclosure relates to converting said ESL, English text, other sentences, Touch Language or tactile language such as Global Touch Language into ASL.

### SUMMARY OF THE INVENTION

In accordance with the instant disclosure, there is described a system and method for converting an English sentence into an American Sign Language sentence (ASL) that when so signed may be understood by deaf and other persons—skilled in understanding ASL, who use or learn to use the American Sign Language. It also enables moving on consecutively to the next sentence and the one after that, performing the same process. The innovation described herein may be utilized in conjunction with the Signtel Interpreter, by its own or in conjunction with other interfacing signing products that convert text to ESL, as well as any text that needs to be converted to ASL.

In one embodiment, an English sentence is submitted to the ASL Converter and comes out as an output as an ASL sentence or as close as possible to it, depending on some facial expressions. Namely, the grammar is the same, though some of the images may not, depending on the specific situation. The converter system is divided into two segments: the pre-processing segment that examines the words in the submitted text and the other segment containing all the rest of the process for the conversion and displaying the content in ASL. When said system is utilized with a signing product, such as the Signtel Interpreter that is based on a U.S. Pat. No. 7,774,194 by Liebermann et al. the system emulates the pre-processor to the Signtel Interpreter, with or without additional signing provided. It may also be functioning independently of the Signtel Interpreter, providing separate signing (i.e., film clips) for the system.

Signing may appear as filmed or as animated, though in the preferred embodiment it will appear as film clips. Said film clips are subsequently fully integrated into a seamless sentence.

The same type of processes may be utilized for conversion from English to other Sign Languages, such as in creating a BSL Converter where English sentences are converted to the British Sign Language, abbreviated as BSL. Other possibilities and embodiments as well as those that ensue from this development are to be considered different embodiments and therefore are also embraced here. Such embodiments are not necessarily English based, and may allow for other languages to be converted to or from English, whereas the same principles may be utilized for translation into Sign language.

### BRIEF DESCRIPTION OF THE DRAWING(S

FIG. 1 illustrates the general conversion

FIG. 2 illustrates elements in the conversion process

FIG. 3 illustrates utility of the Signtel Interpreter in the ESL to ASL conversion.

FIG. 4 illustrates the procedure for generating a color image or color motion on a screen

### DETAILED DESCRIPTION OF THE PREFERRED EMBODIMENT(S)

A sentence is separated into two parts, wherein one part comprises the linguistic part, and the other part contains all the relevant transitional motions of the signing person in the filmed clips. The transitional motions are divided into separate classes wherein one class contains ASL transitional motions and the other class contains operational ASL transitional motions. Said transitional motions are different from those referred to in earlier said work by Liebermann et al.

The process comprising the means for achieving the conversion into ASL in the case of the already existing Signtel Interpreter product can be summarized by the following:
Creating a secondary folder for it called “Signtel Interpreter ASL” that has all the functions of the Signtel Interpreter
Creating two new classes of transitions (ASL transitions & Operational ASL transitions). It should be noted that albeit the similar name of transitions, those transitions are different than the ones already in existence in said existing patent by Liebermann et al.
Creating analysis of sentences
Assigning to each member distinguished by said analysis a characteristics to be considered when signing it
Reorganizing the English sentence according to said distinguished characteristics
Producing the signing objective by using the new of the reorganized (word reorder) sentence with the added appropriate transitions.

It should be noted that some of the new “transitions” that would need to be added require changes in the existing videos utilized in the patent of Liebermann et al., containing facial features during signing. Any such facial features that do not already exist in the said Signtel Interpreter may need to be added and such changes may be accomplished using the technology of Adobe's “After Effects” software. Further, an interim continuation-in-part for said patent of Liebermann et al. comprising an upgrade of facial features may be appropriate and as such is incorporated herein by reference.

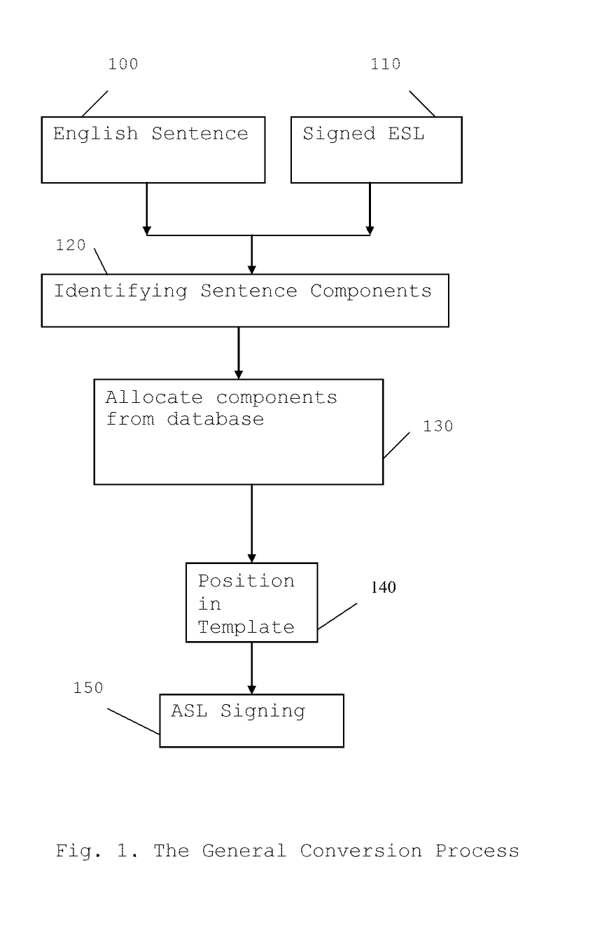

Turning now to FIG. 1, the English sentence in (100) and/or the signed English Sign Language (ESL) in (110) undergo identification for sentence components in (120). Subsequently components from the database are allocated in (130) and positioned in the template(s) in (140), and finally are signed as ASL in (150).

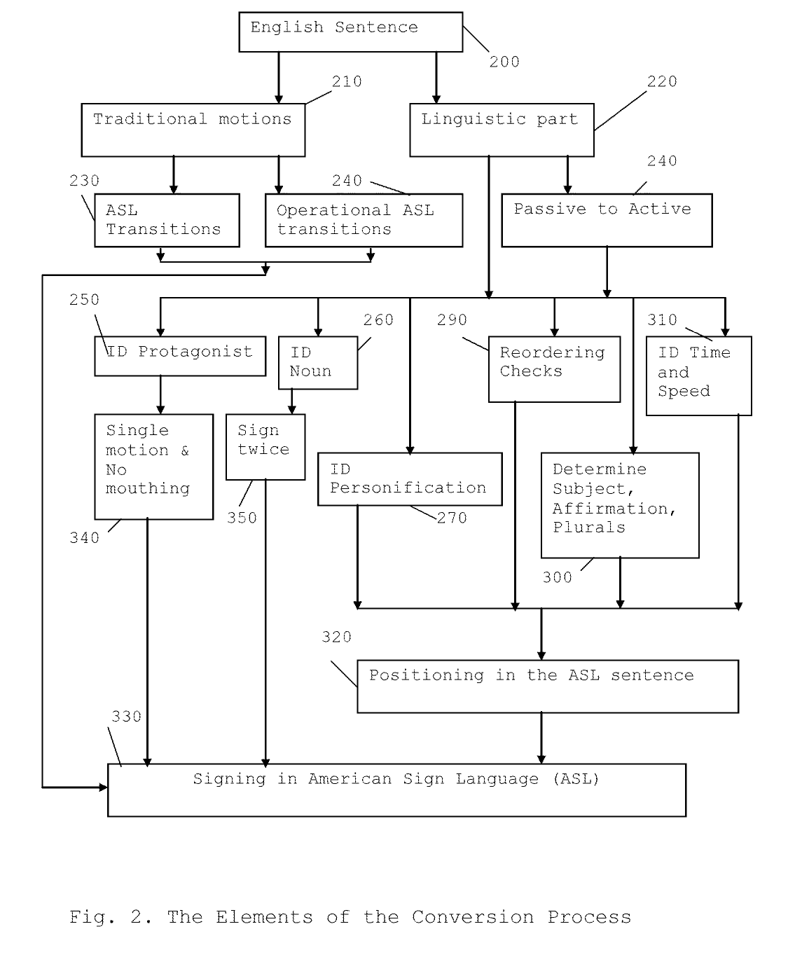

FIG. 2 illustrates the various elements in the conversion process starting with the English sentence in (200) and ending with the ASL signing in (330). The sentence in (200) is divided into two separate processes, the traditional motions in (210) and the linguistic part in (220). The traditional motions in (210) are then divided into ASL “transitions” in (230) and operational ASL “transitions” in (240), where said transitions are motion fillers between the end of one sign and the start of another, in order to provide fully seamless signing motion. Said “filers” end up at the signing process in (330). The linguistic part in (220) handles several elements, such as changing sentences from passive to active expression in (280), time and speed identification in (310), reordering checks in (290) that lead into the positioning in the ASL sentence in (320), determining in (300) the subject, affirmation and whether it is singular or plural), and identifying personification in (270) that leads to the positioning in the ASL sentence in (320). The linguistic part in (220) also handles identification of the protagonist in the sentence in (250) that leads to a single sign motion with no mouthing of the word in (340) from where it goes directly to the signing in (330). The linguistic signing in (220) also handles identification of the noun in (260) that leads to a signing twice of the word in (350) as is shown to the viewer in (330). At the end of the process of the positioning in (320) it all moves into the signing phase in (330).

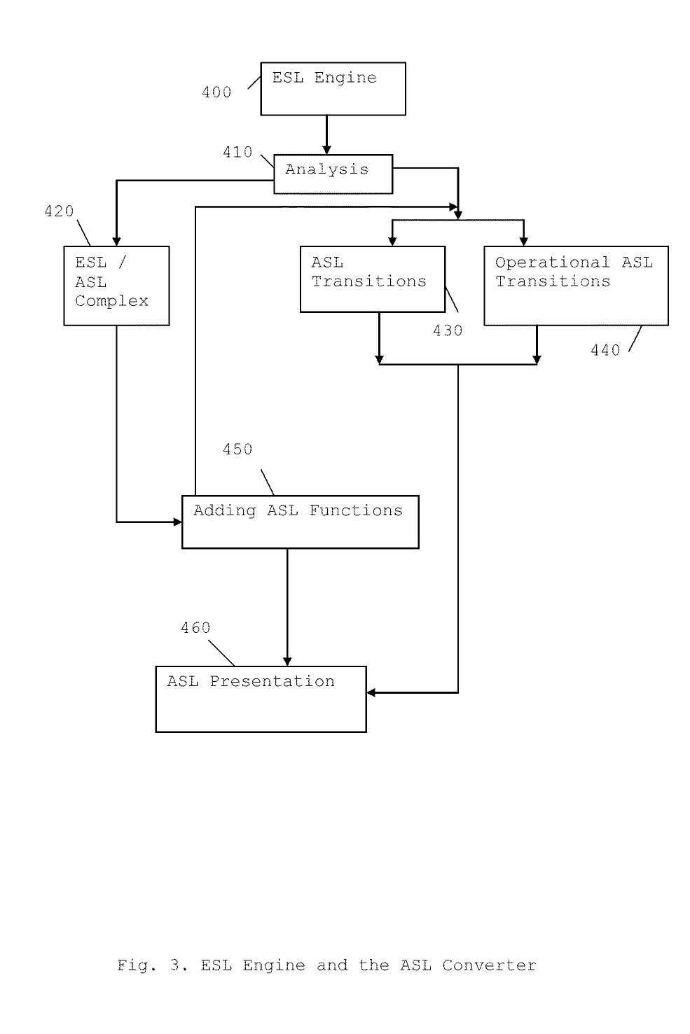

FIG. 3 illustrates the ASL Converter invention when operating with an ESL engine that converts voice and text to English Sign Language (ESL). The system disclosed here utilizes the functionality of the ESL engine for tasks already performed there for economy of procedure to handle some of the operations so that in such an embodiment only certain essential functions have to be administered as added routines in order to obtain the desired conversion form ESL to ASL. The ESL information in (400) is fed into the complex of ESL with ASL segments in (410) that feeds into (440) where the ASL functions have been mixed with the ESL product, to provide in (450) an ASL presentation of the ESL feed in (400). The ASL “transitions” in (420) and the operational ASL “transitions” in (430) are provided to the mixing procedure in (440).

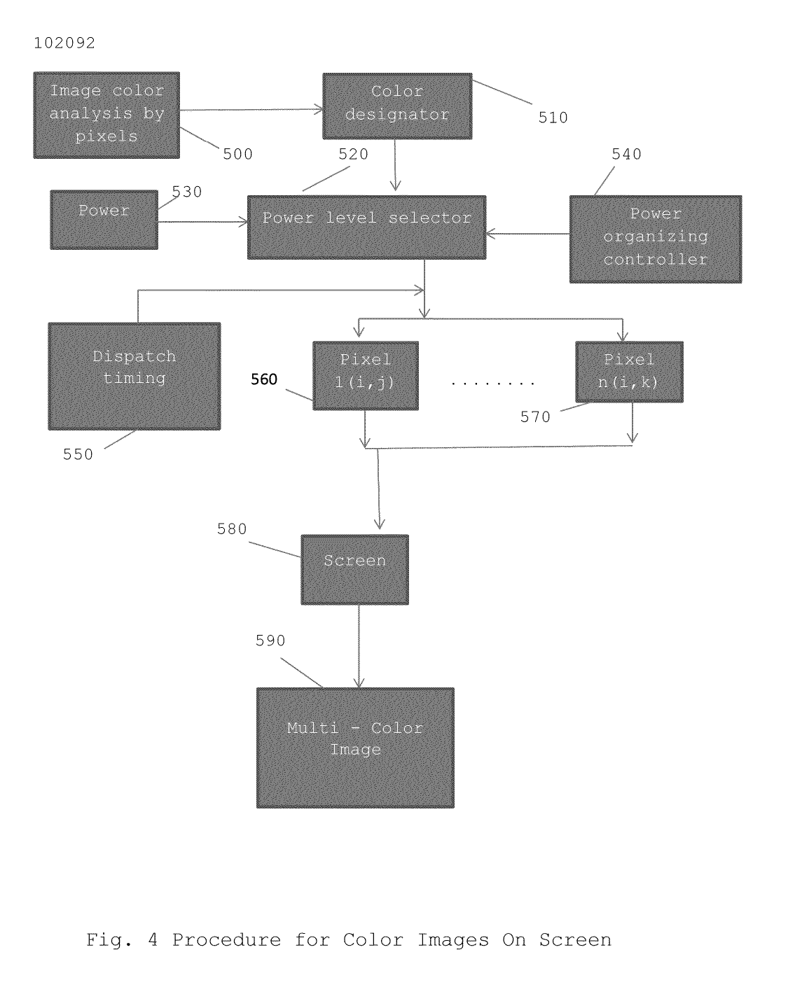

FIG. 4 illustrates the procedure for generating a color image or color motion on a screen, such as a TV screen. The screen is composed of fiber optic filaments, where variations in power provided to each filament within a pixel produces a certain light enabling to see the presentation on the screen in color. Image color analysis occurs in (500), leading to color designator for the various pixels on the screen in (510). Next, a power level is selected in (520) commensurate with the color designator for each pixel on the screen. The power selector in (520) receives the power input from the power source in (530) and utilizes for its selection the input from the controller in (540). The power level selector in (520) provides the appropriate power to each of the filaments resulting in a particular color of light at the end of the filament. Filaments are assigned to specific pixels on the screen and all those filaments aggregated in ant particular pixel carry the same light. Thus, according to the timing designator in (550), the power level selector in (520) feeds each of the filaments of the pixels with the appropriate power resulting in specific light color from the spectrum. All the pixels partake in the powering procedure, starting form the first pixel in the matrix of pixels and denoted in (560) as 1 (i,j), where the first pixel has i=1 and j=1; the pixel to is right would be designated as 2 (i=1;j=2) until the end pixel in (570), where i could be numerically different form j if the screen is not a built as a square. The pixels with their appropriate colors appear therefore on the screen in (580) and produce a multicolor image in (590).

Procedure

The following steps comprise the procedure of the said translation.

1. Turn all passive tense to active tense

2. Identify the person doing the action

3. Identify the action (for the verb)
(a) Said action will have a single motion
(b) Said action it will not be mouthed

4. Identify the noun as it will be signed twice

5. Identify the personification

6. Reorganize the sentence to be by ASL grammar
(a) Check if it is a simple YES/NO question; if it is, then it should not be reordered
(b) Find the subject of the sentence; then position the subject first
(c) Find the comment on the subject; then put the comment next
(d) Find questions which ask who, what, when, where, why, how; then
   (A) Position said questions in said section (d) above at the beginning and end of sentence
   (B) Position a “hold” or “pause” at the end of the question, at the end of the sentence
   (e) Identify the subject in the sentence; then position the subject at the beginning of the sentence
   (f) Find indication of time in the sentence; then position the time indication at the beginning of sentence or; alternatively position the time as close as possible to the subject
   (g) Find time adverbs, such as:
      now, soon, tomorrow, next year, last summer, recently; then treat
      said time adverbs as time elements
   (h) Find if the sentence is conditional; if said sentence is conditional then position the condition part first
      (i.e. eyebrows are raised); then position the comment on the condition second;
      (i.e. eyebrows are lowered)
   (i) Determine if “slow” meaning is transmitted; i.e., (determine the start and end boundaries for conveying “slow”)
   (j) (Use operational transition of slow delivery of signing)
   (k) Determine if “fast” meaning is transmitted; i.e.,
   (l) (Determine the start and end boundaries for conveying “fast”)
   (m) (Use operational transition of fast delivery signing)
   (n) Determine if the classifiers are plural (If said classifiers are plural then use operational transitions
   (o) Determine if orderly arrangement is required; then
   (p) (if said orderly arrangement is required then use operational ASL transitions)
   (q) Determine who is being talked about; then
   (r) (Use appropriate body transitions for the indication)
   (s) Determine if there is a change in the sentence; then
   (t) (Use appropriate body transitions for the indication)
   (u) Determine if affirmation is conveyed by (!); then
   (v) (Replace the textual (!) with the transition “will”)
   (w) Position appropriate transitions (e.g., by their number IDs)
   (x) Release to signing.

Sentence Structure
(1) Short and long sentences will have the same word order structure [Short sentences can have any word order structure and therefore we decree them to be same as long]
(2) The following essential specifics become integral part of the conversion process when created:
   Create personification transition (slide heel of hands down the side of the body from chest to waist)
   Create independent components of mouth as transitions (by filming)
      Mouth transitions for adverbs
      Mouth transitions for adjectives
      Mouthed nouns transitions
   Create independent components of eyes
      Eye shifting
      Eye indexing
      Eyes wide open
      Eye gazing
      Eye squinting
      Breaking eye contact
   Create the head components for different head movements
      Head nod back and forward
      Head nod back and forward with raised eyebrows
      Head nod with tight lip (i.e., affirmation; emphasizing a statement—comes at end of sentence)
      The “will” signing (for affirmation)
   Create body language components
      Tilting the head
      Raising the shoulders
      Body shifting
   Create a transition (signing capsule) for seeking information
      (Head is tilted to the side, eyebrows down and close together)
   Create a transition (signing capsule) for asking a rhetorical question
   (Head tilted to the side or forward, eyebrows up)
   Create a “hold” or pause for end of question at end of sentence
   Create facial expression for adjective
   Create facial expression for adverb
   Create components of the eyes as transitions (by filming)
   Create components of the eyebrows as transitions (by filming)
   Create physical information transition (signing capsule)
      (head tilted forward, shoulders raised, and eyebrows up; the eyes will be open more than usual)
   Integrate the transitions seamlessly into the operational face using for example Adobe “After Effect”. Note is taken that “After Effect” is for animation; the video clip may be imported and the overlay may be used

Operational ASL Transitions

The following may be instituted:
Force a slow delivery of the signing
Force a fast delivery of signing
Force alternate movement of hands [when showing random order]
Force non-dominant hand to be stationary
Force non-dominant hand to provide the movement
Force non-dominant hand to provide the movement by moving in a linear fashion (when plural is appropriate
END Conversion Procedure

At least one of the following databases may provide input for the conversion process:

Verbs list

Nouns list

Adjectives list

Adverbs list

Pronouns list

Question List

Yes/No Question list

Time List

Affirmation List

The ASL Sentence:

The ASL sentence may be built from the English sentence by rearranging the components of the English sentence to look as follows:

SUBJECT then TIME INDICATION then TIME ADVERB
then CONDITION PART then COMMENT ON THE
CONDITION then . . .

This arrangement (or mode) of an ASL sentence may constitute the default case, where the user may choose a different form that may be provided by the invention such as one of the following provided options, or any another preferred option:
Option1: TIME/LOCATION/SUBJECT/ACTION
Option 2: TIME+TOPIC+DESCRIPTION+ACTION+(WH-Q/NEG)

Further, an option may be provided to the user whereby for example a list of styles are provided by way of examples and allows the user to click on the preferred ASL style, thereby creating automatically a converter suitable for the personal needs o the user. As an example of the foregoing, the user may be presented with the option to click on one of the following sentences
1. Morning maybe will rain
2. Morning rain big pour

Preliminary Procedure

### Action 1 (Procedure):

Starting with the first sentence we compare successively each word against the lists of components as per the specific instructions below. Once it is found it in a particular list, it is positioned in the template slot appropriated for the listed category (e.g., verb, noun, adjective, etc.). Next the next word in the sentence is picked up and the process is repeated. When no additional words are left, the sentence template is declared as complete; the sentence template, now appropriately filled up is moved to the signing engine. Thereupon the process is repeated,

utilizing same procedure for the next sentence. The process is looped until no sentences are left.

The Signing engine will determine as shown below, whether to sign, not to sign or sign multiple times the same sign as appropriate. Finally, the appropriate transitions are appropriately inserted in order to be signed and thereby complete a seamless signed ASL sentence.

The Procedure
1. Take first word in sentence B and compare with verb list. If it is a verb then LOCATE IT INTO verb part of ASL SENTENCE TEMPLATE, else;
2. Check it against the noun list;
   if it is a noun then LOCATE IT INTO noun part of ASL SENTENCE TEMPLATE, else;
3. Check adverb list to see if it is an adverb then LOCATE IT INTO the adverb part of the ASL SENTENCE TEMPLATE.
4. Check adjective list
   If it is an adjective then LOCATE IT INTO the adjective part Of the ASL SENTENCE TEMPLATE, else:
5. Check if it is an auxiliary;
   if it is an auxiliary then just IGNORE IT and do NOT locate it into the ASL SENTENCE TEMPLATE (NOTE: The said Signtel Interpreter already takes care of it automatically if so indicated)
6. Check for personification

The Algorithmic Routine Set for the ASL Converter

Verb Algorithm

Take first word in sentence E and compare with VERB list; If there is a match then it is a verb and then LOCATE the word INTO the verb part of ASL SENTENCE TEMPLATE (i.e., SENTENCE A). If there are two verbs in the sentence then locate the order of their appearance: and
1. ID the one appearing first; and
2. ID the one appearing AFTER the word “then”, while the other does not; and
3. ID the one appearing after the comma while the other does not; it is the secondary one; and/or
4. ID the verb that appears BEFORE the word “after” it is the first verb. else; Declare what the verb is and go find the noun being the subject of the sentence BY:
   4.1 Check word-by-word ALL the words appearing BEFORE the declared VERB against the noun list.
   4.2 When a match is found, it is declared as the SUBJECT of the sentence and position it in the First slot of the ASL sentence.

Noun Algorithm

If the word is not a VERB then Check it against the NOUN LIST; if there is a match then declare it as a noun; then LOCATE the word INTO the noun part of the ASL SENTENCE TEMPLATE (SENTENCE A); else

Adverb Algorithm

Check the word against the ADVERB LIST; if there is a match, declare it as an ADVERB and then LOCATE IT INTO the adverb part of the ASL SENTENCE TEMPLATE SENTENCE A); else

Adjective Algorithm

Check the word against the ADJECTIVE LIST; if there is a match then declare it as an adjective then LOCATE IT INTO the adjective part Of the ASL SENTENCE TEMPLATE (SENTENCE A); else

Auxiliary Algorithm

This algorithm is not needed in this version as it was taken care off when SENTENCE E was submitted to the Signtel Interpreter before it arrived at this module; the Signtel Interpreter has an option and once activated it will automatically have the auxiliary removed).

Pronoun Algorithm

Take the word and look for a match in the PRONOUN LIST; if there is a match, it is declared as a pronoun; then assign to the pronoun word a serial number in the sentence to be the serial number of the word preceding it+1. Next keep numbering each word by taking the current word−1 until getting to a word with serial number 1; next continue to provide serial number to the word immediately following the pronoun by adding 1 (i.e., “pronoun=pronoun+1”); now proceed.

Additional Considerations
(A) Identify if a question is a simple Yes/No answer question
1. ID a question by looking for words in the QUESTION LIST
2. See if you have a pronoun following a word in the list [If it is then declare it a
   YES/NO question and do not reorder in the sentence
3. Determine if it is a question answerable with a simple Yes or NO
a. Go to YES/NO question list;
b. Search if any word appearing in the list appears also in the sentence;
c. If it appears, then declare the sentence as needing a yes/no answer; and
d. Exempt it from reordering; (in other words, keep it as is).
(B) Turn all Passive tense to Active tense
1. Look for the word HAVE in the sentence
2. Look for the word BEEN in the sentence
3. Look for the word WAS followed by a verb ending with (e.g. en,)
a. First look for the word WAS; then
b. Look for the verb in the VERB DATABASE; then
c. Go across on same line to find if the word in next column is a passive voice VERB that matches your case; then
d. If it does, then use the VERB form first column in TEMPLATE (B); then
e. Put the proper pronoun
4. Position the words in TEMPLATE (B) (The ACTIVE TENSE TEMPLATE)
(C) Identify the Person doing the Action (BY CONSULTING THE pronoun table)
1. Consult the first column in the PRONOUN TABLE and ID the verb; then if it is not:
(D) Find the subject of the sentence.
(E) Find indication of time in the sentence
1. Look for any word in the TIME LIST. If it is there, it means indication of time.
(F) Find if the sentence is conditional
(G) Find the comment on the condition
(H) Find if affirmation is indicated
1. Look at AFFIRMATION LIST to find a match with the sentence
2. If a match is found then affirmation is indicated.

Second Approach

In one embodiment, the English sentence may be submitted to the said Signtel Interpreter; whereupon the following may take place:
a. Identifying the auxiliaries; and
b. Handling aspects of multiple meanings; and
c. Handling aspects of idioms; then.
d. Send it to the ASL converter; and
e. Convert the English sentence structure to ASL sentence structure; then
f. After conversion to ASL style it is sent back to the Signtel Interpreter; and
g. The rest is function flow, such as forced finger spelling, the “dis”, “un”, etc.;
h. Finally, it is submitted to the video production as usual. The signing box then shows the video as usual, but now with the changed sentence to ASL structure.

Reading on Electronic Ink Display with Colors

There are electronic reading tablets for books, such as the Kindle by Amazon that even has the technology of providing ability to read outdoors in the Sun without a glare. However, pictures in color are not yet available. While our ASL Converter can operate on a black and while display, the technology disclosed below enables to do it in color as well. It is based on technology developed by the applicant and registered in a dated patent book showing the date of Sep. 28, 1979. It is based on creating the screen panel from fiber optic filaments acting as “wires” wherein varying electrical pulses at one end (the pixel generating end) of a fiber causes varying colors of light to show at the other end, where the viewer can see the pixels in colors. Thus, this invention is incorporated herein by reference.

The Reverse Direction ASL To English Converter When a hearing impaired person who signs ASL arrives at an emergency room in a hospital he or she may understand what the medical staff says because they can either use voice recognition or text in conjunction with the ASL converter that will enable the person to see what is said or the text to him or her in ASL sign language. However, when that person responds, such as entering text into the Signtel Interpreter, it is in ESL and as such will be meaningless or at best difficult to comprehend for the medical staff. The ASL to English converter resolves that problem and the text entered by the person utilizing ASL may appear in English to the medical staff or voiced to them that way.

In essence the process outlined above is reversed, whereby the construct of the ASL converter (English to ASL) proceeds sentence by sentence however, the task here is complicated in the sense that in the English to ASL we go from a maximal full sentence to a reduced sentence, while in the reverse we start from a minimalist sentence and have to account for proper times and tense that do not exist in ASL. Further, while in ASL the locations for the subject, the time, etc is fixed, this is not the case in the English sentence and requires a different approach for the construction of the English sentence from the ASL sentence and is disclosed herein.

Cognitive Disability

Same conversion procedure as disclosed herein may also be useful for persons with cognitive disability, or persons versed in another language altogether who need translation in a simple and understandable form. As such an additional database is provided with images, wherein at least one of a pictures, animations, or cartoons constitute the material in said database. In that regards, said images would either be added or provide the complete articulated voice or text.

Lip Reading

Right now the signer enunciates the words that enable lip reading. So a person (say late deaf) who reads lips can also consult the text from time to time. However, under the conversion to ASL there are words that are not mouthed (in ASL), putting the late deaf at a disadvantage (as they will be missing words for comprehension). We advance the following solution in the converter.

The embodiment for persons who read lips departs from identifying what needs to put in certain locations of the disclosed template and instead the system identifies what is not needed in a sentence and takes it out. Namely, only essentials of each sentence are kept rather than selecting components and positioning them. For example, let us look at the following:

### “I WILL GO TO THE STORE TO BUY FOOD.”

When said sentence is repeated with the essentials underlined, we have:

“I WILL GO TO THE STORE TO BUY FOOD; namely, “I GO STORE BUY FOOD”
Let's take another sentence:

### “THE JUDGE DECIDED JEREMY DID NOT DO ANYTHING WRONG AND LET HIM GO.”

Underlining only the essentials the sentence becomes:
“THE JUDGE DECIDED JEREMY DID NOT DO ANYTHING WRONG AND LET HIM GO;” namely

### “JUDGE DECIDED JEREMY NOT DO WRONG LET GO”

We note that in ASL the sentence should be:

### “JUDGE LET JEREMY GO NOT DO WRONG”

Thus some transposition may be needed.
Let's look at another case:

### “THE MAN SCREAMED WHEN HE SAW THE NEIGHBOR POINTING THE GUN AT THE SQUIRREL.”

Underlining the important elements we get:

### “THE MAN SCREAMED WHEN HE SAW THE NEIGHBOR POINTING THE GUN AT THE SQUIRREL.” Namely,

### “MAN SCREAMED SAW NEIGHBOR POINTING GUN AT SQUIRREL”

It is noted that in ASL, same sentence would appear as:

### “NEIGHBOR POINT GUN SQUIRREL MAN SEE SCREAM”.

Thus in the embodiment for lip reader repositioning may be chosen as the procedural route.

As can be seen from the foregoing description, an ASL conversion system has been provided, as well as a new type of color screen. While the present invention has been described in the context of specific embodiments thereof, other alternatives, modifications, and variations may become apparent to those skilled in the art having read the foregoing description. Accordingly, it is intended to embrace those alternatives, modifications, and variations.

What is claimed is:

1. The method of translation between languages for converting at least one of a communication, expression, and presentation in a specific language comprising at least one of a textual and voiced language, at least one of a tactile language, and sign language to at least one of a communication, expression, and presentation in another language comprising at least one of a textual and voiced language, at least one of a tactile language, and sign language wherein same context and meaning of the language translated from is at least one of a maintained and preserved in the language translated to.

2. The method of claim 1 wherein said at least one of a specific and another language is the English language.

3. The method of claim 1 wherein said at least one of a specific and another sign language is at least one of a English sign language (ESL) and American Sign Language (ASL).

4. The method of claim 1 wherein said at least one of a specific and another sign language is at least one of a American Sign Language (ASL), British sign Language (BSL), cued speech, Pidgin Sign English (PSE), finger-spelling, and at least one of a at least one other sign language(s) and at least one other dialect(s).

5. The method of claim 1 wherein said at least one of a specific and another language at least one of a maintain and preserve the same context and meaning of the language translated from in the language translated to and wherein the language translated to maintains its own form comprising of at least one of a grammar, syntax and at least one other idiosyncratic attribute(s) including one of a added Filler parts or omitting parts not commensurate with said form of said language translated to.

6. The method of claim 1 wherein at least one of a transitions, and operational transitions are utilized.

7. The method of claim 1 wherein the conversion process comprise at least one of a transformation from passive to active, transformation from active to passive, identification of at least one of a at least one protagonist(s), at least one noun, personification, identification of time and speed, determination regarding a single motion and no mouthing, plural signing, subject and affirmation of plurals.

8. The method of claim 1 wherein the result of analyzing components of the language translated from, constructing the presentation in the target language translated to results in at least one sentence(s) of seamless presentation wherein the at least one of a context and meaning of the language translated from is at least one of a maintained and preserved in said target language translated to.

9. The system of translation between languages for converting at least one of a communication, expression, and presentation in a specific language comprising at least one of a textual and voiced language, tactile language, and sign language to at least one of a communication, expression, and presentation in another language comprising at least one of a textual or voiced language, tactile language, and sign language wherein same context and meaning of the language translated from is at least one of a maintained and preserved in the language translated to.

10. The system of claim 9 wherein said at least one of a specific and another language is the English language.

11. The system of claim 9 wherein said at least one of a specific and another sign language is at least one of a English sign language (ESL) and American Sign Language (ASL).

12. The system of claim 9 wherein said at least one of a specific and another sign language is at least one of a American Sign Language (ASL), British sign Language (BSL), cued speech, Pidgin Sign English (PSE), finger-spelling, and at least one other of at least one other sign language(s) and at least one other dialect(s).

13. The system of claim 9 wherein said at least one of a specific and another language at least one of a maintain and preserve the same context and meaning of the language translated from in the language translated to and wherein the language translated to maintains its own form comprising of at least one of a grammar, syntax and at least one other idiosyncratic attribute(s) including one of a added Filler parts or omitting parts not commensurate with said form of said language translated to.

14. The system of claim 9 wherein at least one of a transitions, and operational transitions are utilized to construct the resulting sign language.

15. The system of claim 9 wherein the conversion process comprise at least one of a transformation from passive to active, transformation from active to passive, identification of at least one of a at least one protagonist(s), at least one noun, personification, and identification of time and speed, determination regarding time and speed, determination regarding a single motion and no mouthing, plural signing, subject, and affirmation of plurals.

16. The system of claim 9 wherein the result of analyzing components of the language translated from, constructing the presentation in the target language translated to results in at least one sentence(s) of seamless presentation wherein the at least one of a context and meaning of the language translated from is at least one of a maintained and preserved in said target language translated to.

17. A system for color display comprising a screen comprising multiple fiber optic filament endings for showing at least one image(s) on said screen wherein light at each said fiber optic filament ending has at least one of a same and different color.

18. The system of claim 22 wherein each fiber optic filament receives at each successive unit of time a level of power that is at least one of a same and different than the power level pulse preceding it for generating a specific optical frequency at said filament ending.

19. The system of claim 17 wherein each pixel of said screen comprises at least one fiber optic filament wherein all fiber optic filaments comprising any pixel exhibit same optical frequency.
